(19) United States
(12) Patent Application Publication
(10) Pub. No.: US 2022/0412722 A1
(43) Pub. Date: Dec. 29, 2022

(54) OPTICAL SENSOR AND GEOMETRY MEASUREMENT APPARATUS

(71) Applicant: Mitutoyo Corporation, Kawasaki (JP)

(72) Inventor: Kimitoshi Ono, Kanagawa (JP)

(21) Appl. No.: 17/744,220

(22) Filed: May 13, 2022

(30) Foreign Application Priority Data
Jun. 23, 2021 (JP) 2021-103903

(51) Int. Cl. G01B 11/03; G02B 26/10

(52) U.S. Cl. CPC G01B 11/03; G02B 26/105

(57) ABSTRACT

An optical sensor includes a radiation part that irradiates an object to be measured with line shaped light; and an imaging part that receives line shaped light reflected by the object to be measured and captures an image of the object to be measured in a predetermined exposure time. The radiation part includes a light generation part that generates the line shaped light, and a light vibration part that irradiates the object to be measured with the line shaped light generated by the light generation part while vibrating the line shaped light in a length direction during the exposure time.

### CROSS-REFERENCE TO RELATED APPLICATIONS

The present application claims priority to Japanese Patent Applications number 2021-103903, filed on Jun. 23, 2021. The contents of this applications are incorporated herein by reference in their entirety.

### BACKGROUND OF THE INVENTION

The present disclosure relates to an optical sensor and a geometry measurement apparatus.

In a geometry measurement apparatus, a non-contact type of optical sensor is used to measure a cross-sectional shape of an object to be measured using a light section method based on a triangulation principle. The optical sensor irradiates the object to be measured with line shaped light, and captures an image of the object to be measured on the basis of light reflected from a surface of the object to be measured (see Japanese Patent No. 5869281).

In the optical sensors, the line shaped light in a straight line is radiated to the object to be measured, but due to an error caused by a lens component included in the optical sensor or the like, distribution of the line shaped light on the surface of the object to be measured may be undulating instead of straight. In this case, an imaging part captures an undulating image, resulting in an error in the measurement of the geometry of the object to be measured.

### BRIEF SUMMARY OF THE INVENTION

The present disclosure focuses on this point, and an object of the present disclosure is to suppress a measurement error when an object to be measured is measured by radiating line shaped light thereto.

### Means for Solving the Problems

A first aspect of the present disclosure provides an optical sensor including a radiation part that irradiates an object to be measured with line shaped light, and an imaging part that receives line shaped light reflected by the object to be measured and captures an image of the object to be measured in a predetermined exposure time, wherein the radiation part includes a light generation part that generates the line shaped light, and a light vibration part that irradiates the object to be measured with the line shaped light generated by the light generation part while vibrating the line shaped light in a length direction during the exposure time.

### BRIEF DESCRIPTION OF THE DRAWINGS

FIG. 1 is a schematic diagram illustrating a configuration of an optical sensor 10 according to the first embodiment.

FIG. 2 is a block diagram illustrating the configuration of the optical sensor 10.

FIGS. 3A to 3B are schematic diagrams illustrating the configuration of the optical sensor 10.

FIG. 4 is a schematic diagram illustrating a configuration of an optical sensor 110 according to a comparative example.

FIGS. 5A to 5B are schematic diagrams illustrating an image formed on an imaging part 40 in the comparative example.

FIG. 6 is a schematic diagram illustrating the image formed on the imaging part 40 in the present embodiment.

FIGS. 7A to 7B are schematic diagrams illustrating rocking of a rocking mirror 54.

FIG. 8 is a schematic diagram illustrating a configuration of a geometry measurement apparatus 1.

FIGS. 9A to 9B are schematic diagrams illustrating the configuration of the optical sensor 10 according to the second embodiment.

FIG. 10 is a schematic diagram illustrating the configuration of the optical sensor 10 according to the third embodiment.

### DETAILED DESCRIPTION OF THE INVENTION

### First Embodiment

### (Configuration of Optical Sensor)

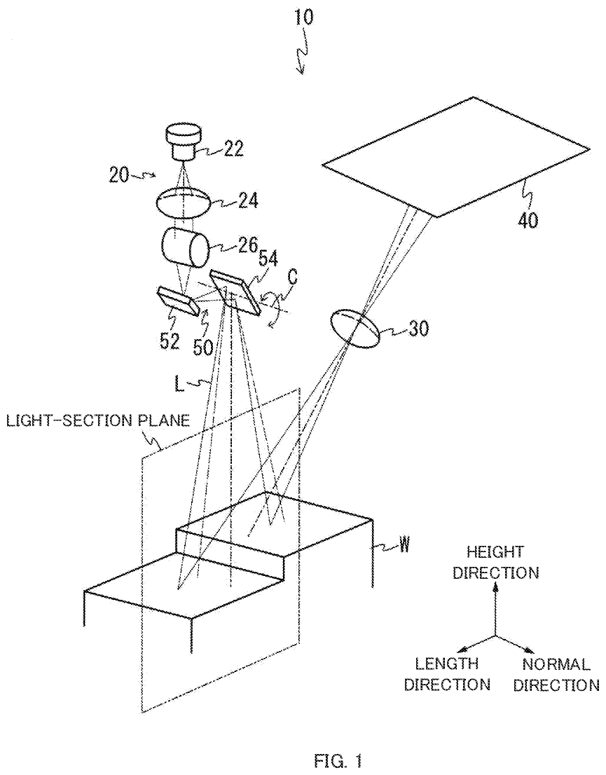

A configuration of an optical sensor according to the first embodiment will be described with reference to FIGS. 1 to 3.

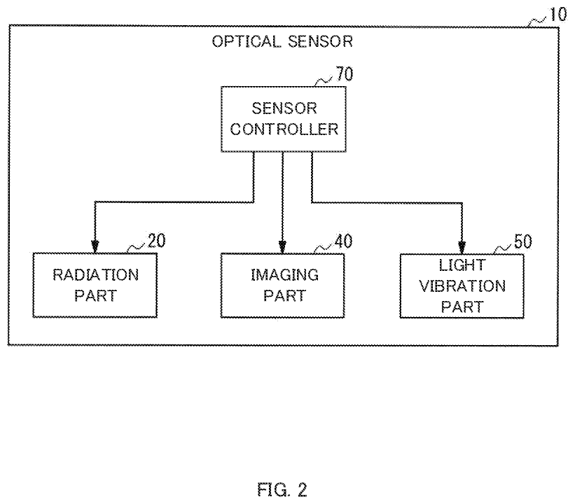

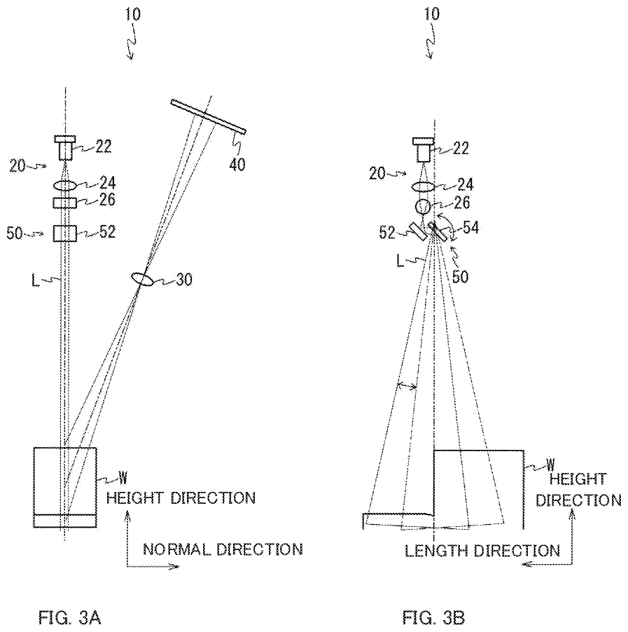

FIG. 1 is a schematic diagram illustrating a configuration of an optical sensor 10 according to the first embodiment. FIG. 2 is a block diagram illustrating the configuration of the optical sensor 10. FIG. 3A shows the optical sensor 10 of FIG. 1 viewed from a direction of a length direction (see FIG. 1) of line shaped light L, and FIG. 3b shows the optical sensor 10 viewed from a normal direction of a light-section plane (see FIG. 1).

The optical sensor 10 is used to measure a cross-sectional shape of an object to be measured W at the light-section plane (in FIG. 1, geometry of a stepped portion of the object to be measured W). Specifically, the optical sensor 10 irradiates the object to be measured W with the line shaped light L, and captures an image of the object to be measured W on the basis of light reflected from a surface of the object to be measured W. As shown in FIGS. 1 and 2, the optical sensor 10 includes a radiation part 20, an image forming lens 30, an imaging part 40, a light vibration part 50, and a sensor controller 70.

The radiation part 20 irradiates the object to be measured W with the line shaped light L. Specifically, the radiation part 20 deforms laser light into the line shaped light L and irradiates the object to be measured W with the line shaped light L. As shown in FIG. 1, the radiation part 20 includes a light source 22, a collimator lens 24, and a cylindrical lens 26.

The light source 22 is formed by a Laser Diode (LD) or the like, for example, and generates and emits the laser light. The light source 22 emits the laser light with a predetermined wavelength.

The collimator lens 24 collimates the laser light emitted from the light source 22. The collimator lens 24 is a convex lens in this embodiment.

The cylindrical lens 26 deforms parallel light (laser light) from the collimator lens 24 into the line shaped light L having a line shape. In the present embodiment, the cylindrical lens 26 corresponds to a light generation part that generates the line shaped light L.

An image forming lens 30 forms an image of the line shaped light L, which is reflected light reflected by the object to be measured W, on an imaging surface of the imaging part 40. The image forming lens 30 here is a convex lens.

The imaging part 40 is an image sensor such as a CMOS, for example, and captures the image of the object to be measured W. The imaging part 40 receives the line shaped light L reflected by the object to be measured W, and captures the image of the object to be measured W in a predetermined exposure time. That is, the imaging part 40 captures an image of light distribution indicating the cross-sectional shape of the object to be measured W at the light-section plane. As shown in FIG. 1, the imaging part 40 is arranged in a direction at a predetermined angle with respect to a radiation direction of the light radiated from the radiation part 20 to the object to be measured W, and receives the light reflected by the surface of the object to be measured W from the predetermined angle.

Incidentally, although the line shaped light Lin a straight line is radiated to the object to be measured W, due to an error or the like caused by a lens component included in the optical sensor 10, distribution of the line shaped light L on the surface of the object to be measured W may be undulating instead of straight. Specifically, the distribution of the line shaped light L undulates in the normal direction of the light-section plane. In this case, the imaging part 40 captures an undulated image, resulting in an error in the measurement of the geometry of the object to be measured W.

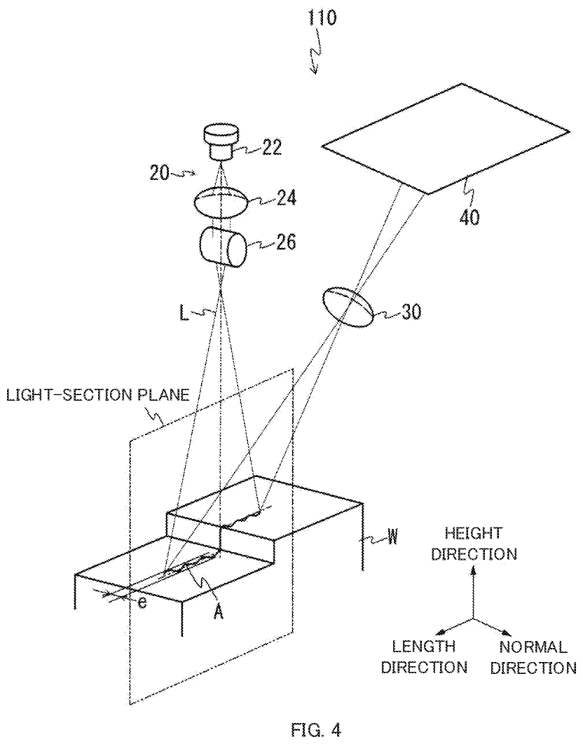

FIG. 4 is a schematic diagram illustrating a configuration of an optical sensor 110 according to a comparative example. The optical sensor 110 according to the comparative example includes the radiation part 20, the image forming lens 30, and the imaging part 40, similarly to the optical sensor 10 described above. On the other hand, the optical sensor 110 is not provided with the light vibration part 50 of the optical sensor 10. In the comparative example, as shown in FIG. 4, the distribution A of the line shaped light L is undulated by an error e in the normal direction.

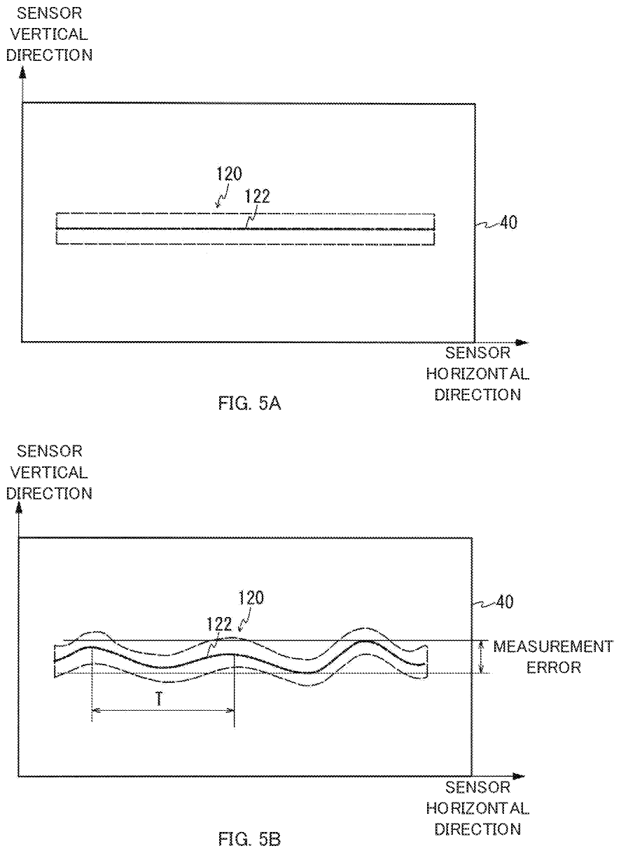

FIGS. 5A to 5B are schematic diagrams illustrating an image formed on the imaging part 40 in the comparative example. The horizontal axes in FIGS. 5A to 5B indicate the horizontal direction of an image sensor that is the imaging part 40, and the vertical axes in FIGS. 5A to 5B indicate the vertical direction of the image sensor. Here, it is assumed that a portion surrounded by a broken line is an image 120 having a predetermined width formed on the imaging part 40. A peak portion 122 of the light distribution of the image 120 represents the cross-sectional shape of the object to be measured W, and is shown by a dashed line here. FIG. 5A shows the image 120 in an ideal case where there is no error caused by the lens component. In the ideal case, the peak portion 122 is a straight line. On the other hand, if the distribution of the line shaped light L is undulated in the normal direction as shown in FIG. 4 due to the error caused by the lens component in the optical sensor 110 according to the comparative example, the image 120 captured by the imaging part 40 will have an undulated shape as shown in FIG. 5B. As a result, the peak portion 122 also has the undulated shape, resulting in an increase of the measurement error of the object to be measured W.

In contrast, in the optical sensor 10 of the present embodiment, the radiation part 20 is provided with the light vibration part 50 in order to suppress the measurement error. The light vibration part 50 vibrates the line shaped light L radiated to the object to be measured W, and averages out the undulation of the line shaped light L in the normal direction of the light-section plane. Specifically, the light vibration part 50 irradiates the object to be measured W with the line shaped light L while vibrating the line shaped light L in the length direction during the exposure time of the imaging part 40. Thus, the imaging part 40 captures the image of the line shaped light L vibrating during the exposure time, and the image formed on the imaging surface of the imaging part 40 has averaged-out undulation in the normal direction.

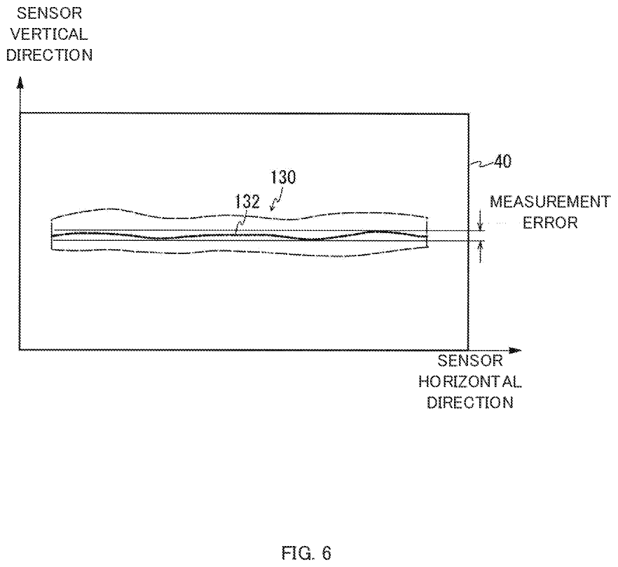

FIG. 6 is a schematic diagram illustrating the image formed on the imaging part 40 in the present embodiment. An image 130 formed on the imaging part 40 shown in FIG. 6 has averaged-out undulation compared to the image 120 shown in FIG. 5B. Further, the undulation of a peak portion 132 is also reduced, such that the measurement error of the object to be measured W can be suppressed.

The light vibration part 50 irradiates the object to be measured W with the line shaped light L while causing the line shaped light L to make one reciprocation in the length direction during the exposure time of the imaging part 40. It should be noted that the present disclosure is not limited to the above, and the light vibration part 50 may irradiate the object to be measured W with the line shaped light L while causing the line shaped light L to reciprocate a plurality of times in the length direction during the exposure time of the imaging part 40. That is, the light vibration part 50 reciprocates the line shaped light at least once in the length direction during the exposure time. This makes it easier to average out random undulations in the normal direction of the line shaped light L.

The light vibration part 50 irradiates the object to be measured W with the line shaped light L having a predetermined cycle in the length direction while vibrating the line shaped light L such that the line shaped light L is shifted by ½ or more of the cycle. For example, the light vibration part 50 vibrates the line shaped light L such that the line shaped light L is shifted by ½ of a cycle T shown in FIG. 5B. By shifting the line shaped light L by ½ or more of the cycle, it becomes easier to average out the undulation in the normal direction of the line shaped light L. It should be noted that the above predetermined cycle may be determined and set in advance by experiment or the like.

As shown in FIG. 1, the light vibration part 50 includes a plane mirror 52 and a rocking mirror 54.

The plane mirror 52 reflects the line shaped light L from the cylindrical lens 26 toward the rocking mirror 54. Here, the plane mirror 52 reflects the line shaped light L by 90°. The plane mirror 52 is a fixed mirror.

The rocking mirror 54 is a mirror that directs the line shaped light L reflected from the plane mirror 52 toward the object to be measured W. Here, the rocking mirror 54 reflects the line shaped light L vertically downward. The rocking mirror 54 rocks to vibrate the line shaped light L directed toward the object to be measured W. The rocking mirror 54 rocks about an axis C (see FIG. 1) in a normal direction perpendicular to the length direction of the line shaped light L. For example, the rocking mirror 54 rocks within a predetermined angular range (for example, several degrees) once during the exposure time. However, the present disclosure is not limited thereto, and the rocking mirror 54 may rock within the predetermined angular range a plurality of times during the exposure time. That is, the rocking mirror 54 rocks at least once during the exposure time.

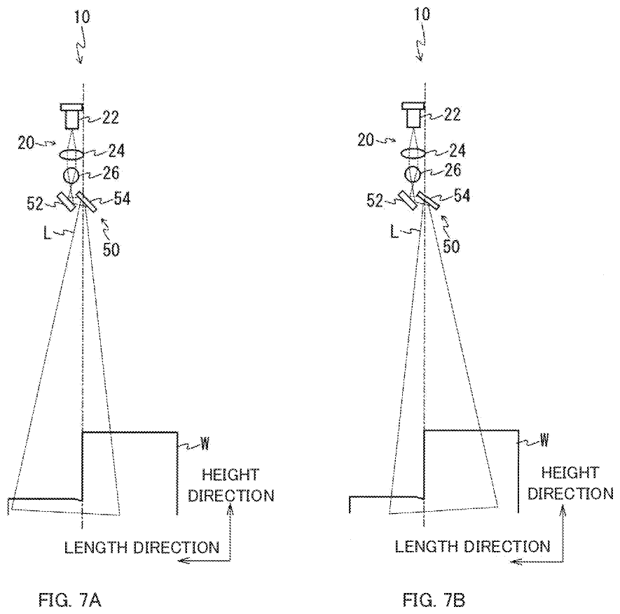

FIGS. 7A to 7B are schematic diagrams illustrating rocking of the rocking mirror 54. The rocking mirror 54 rocks by rotating between a first position shown in FIG. 7A and a second position shown in FIG. 7B. When the rocking mirror 54 rocks between the first position and the second position, the line shaped light L vibrates in the length direction. It should be noted that a Micro Electro Mechanical Systems (MEMS) scanner, a Galvano scanner, a resonant scanner, or the like are used as the rocking mirror 54.

The sensor controller 70 controls an operation of the optical sensor 10. The sensor controller 70 controls the radiation of the laser light by the radiation part 20 and the capturing of the image of the object to be measured W by the imaging part 40.

The sensor controller 70 controls the vibration of the line shaped light L by the light vibration part 50. For example, the sensor controller 70 rocks the rocking mirror 54 of the light vibration part 50 at high speed to vibrate the distribution of the line shaped light L at high speed in the length direction. Further, the sensor controller 70 controls the exposure of the imaging part 40 and the vibration of the line shaped light L in the length direction by the light vibration part 50 such that they are synchronized with each other. For example, the sensor controller 70 controls the operations of the imaging part 40 and the light vibration part 50 such that the conditions of the exposure time of the imaging part 40 and the rocking angle of the rocking mirror 54 of the light vibration part 50 are constant. Thus, the imaging part 40 can capture the image of the object to be measured W when the line shaped light L vibrates.

### (Configuration of Geometry Measurement Apparatus)

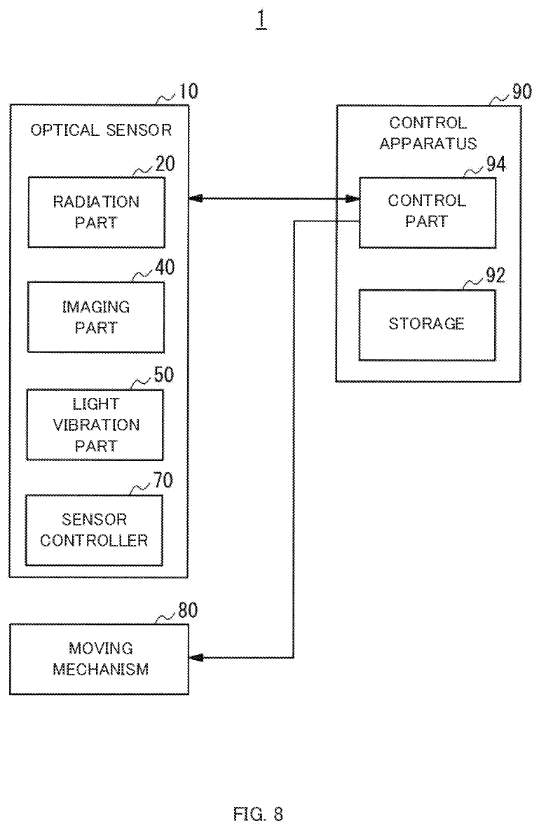

A configuration of a geometry measurement apparatus 1 including the optical sensor 10 having the above-described configuration will be described with reference to FIG. 8.

FIG. 8 is a schematic diagram illustrating the configuration of the geometry measurement apparatus 1. The geometry measurement apparatus 1 measures the geometry of the object to be measured W on the basis of a detection result of the imaging part 40 of the optical sensor 10. The geometry measurement apparatus 1 is a coordinate measurement apparatus that measures the geometry of an object to be measured, for example. As shown in FIG. 8, the geometry measurement apparatus 1 includes the optical sensor 10, a moving mechanism 80, and a control apparatus 90.

Since the configuration of the optical sensor 10 is as described above, a detailed description thereof will be omitted here. The moving mechanism 80 moves the optical sensor 10. For example, the moving mechanism 80 moves the optical sensor 10 in three axial directions orthogonal to each other.

The control apparatus 90 controls the operation of the optical sensor 10 (specifically, the radiation part 20, the imaging part 40, and the light vibration part 50) and the moving mechanism 80. Further, the control apparatus 90 performs the measurement using the optical sensor 10 by moving the optical sensor 10 with the moving mechanism 80, for example. The control apparatus 90 includes a storage 92 and a control part 94.

The storage 92 includes a Read Only Memory (ROM) and a Random Access Memory (RAM), for example. The storage 92 stores various types of data and a program executed by the control part 94. For example, the storage 92 stores a result of the measurement by the optical sensor 10.

The control part 94 is a Central Processing Unit (CPU), for example. The control part 94 executes the program stored in the storage 92 to control the operation of the optical sensor 10 via the sensor controller 70. Specifically, the control part 94 controls the radiation of the laser light to the object to be measured W by the light source 22 of the radiation part 20. Further, the control part 94 acquires an output of the imaging part 40 and calculates the geometry of the object to be measured W. In the present embodiment, the control part 94 functions as a calculation part that calculates the geometry of the object to be measured W on the basis of the output of the imaging part 40.

### Effect of the First Embodiment

In the optical sensor 10 of the first embodiment, the radiation part 20 includes the light vibration part 50 that irradiates the object to be measured W with the line shaped light L while vibrating the line shaped light L in the length direction during the exposure time of the imaging part 40.

Thus, even if the line shaped light L undulates in the normal direction on the surface of the object to be measured W due to an error or the like caused by the lens component of the optical sensor 10, the image formed on the imaging surface of the imaging part 40 will have the averaged-out undulation since the imaging part 40 captures the vibrating line shaped light L during the exposure time. As a result, it is possible to suppress the measurement error of the object to be measured W caused by the undulation of the line shaped light L in the normal direction.

### Second Embodiment

In the second embodiment, the configuration of the light vibration part 50 is different from that in the first embodiment, and the other configurations are the same as those in the first embodiment.

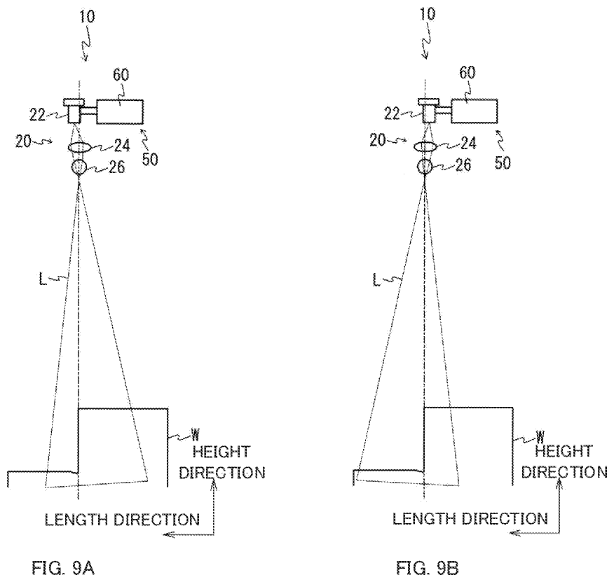

FIGS. 9A to 9B are schematic diagrams illustrating the configuration of the optical sensor 10 according to the second embodiment. The light vibration part 50 of the second embodiment includes an actuator 60 provided in the vicinity of the light source 22, instead of the plane mirror 52 and the rocking mirror 54 of the first embodiment.

The actuator 60 reciprocates the radiation part 20 and the light source 22 in the length direction of the line shaped light L. The light source 22 is reciprocated between a first position shown in FIG. 9A and a second position shown in FIG. 9B by the actuator 60. On the other hand, the collimator lens 24 and the cylindrical lens 26 of the radiation part 20 do not move. Therefore, when the light source 22 is located at the first position, the laser light is radiated to the object to be measured W as shown in FIG. 9A, and when the light source 22 is located at the second position, the laser beam is radiated to the object to be measured W as shown in FIG. 9B. As can be seen from a comparison between FIGS. 9(a) and 9(b), when the light source 22 is displaced, the line shaped light L in the length direction is also displaced. Therefore, when the light source 22 is reciprocated, the line shaped light L vibrates in the length direction.

Also in the second embodiment, during the exposure time of the imaging part 40, the light vibration part 50 reciprocates the light source 22 in the length direction of the line shaped light L using the actuator 60 to vibrate the line shaped light L in the length direction. Therefore, the imaging part 40 captures the image of the object to be measured W when the line shaped light L vibrates. Thus, even if the line shaped light L undulates in the normal direction on the surface of the object to be measured W, the image formed on the imaging surface of the imaging part 40 will have the averaged-out undulation. As a result, it is possible to suppress the measurement error of the object to be measured W caused by the undulation in the normal direction of the line shaped light L.

### (Variation)

In the above description, the actuator 60 reciprocates the light source 22 to vibrate the line shaped light L, but the present disclosure is not limited thereto. The actuator 60 may reciprocate the collimator lens 24 and the cylindrical lens 26 in the length direction of the line shaped light L instead of the light source 22. For example, like the light source 22 shown in FIGS. 9A to 9B, the actuator 60 reciprocates the collimator lens 24 and the cylindrical lens 26 between two positions. When the collimator lens 24 and the cylindrical lens 26 are reciprocated, the line shaped light L vibrates in the length direction.

Also in the variation, the light vibration part 50 reciprocates the collimator lens 24 and the cylindrical lens 26 using the actuator 60 during the exposure time of the imaging part 40, and the line shaped light L vibrates in the length direction. Thus, the imaging part 40 captures the image of the object to be measured W when the line shaped light L vibrates.

### Third Embodiment

In the third embodiment, the configuration of the light vibration part 50 is different from that in the first embodiment, and the other configurations are the same as those in the first embodiment.

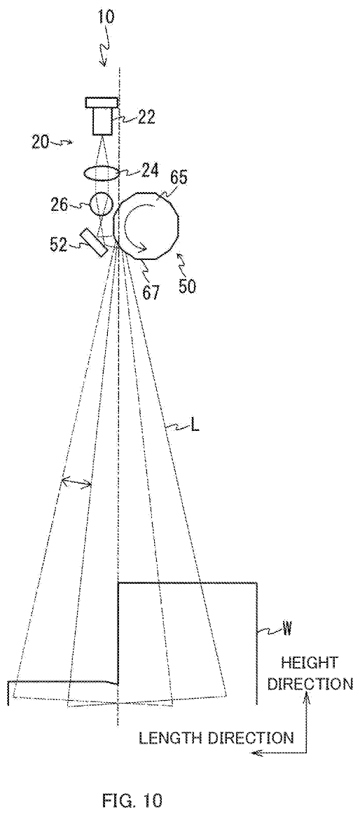

FIG. 10 is a schematic diagram illustrating the configuration of the optical sensor 10 according to the third embodiment. The light vibration part 50 of the third embodiment includes a rotating mirror 65 instead of the rocking mirror 54 of the first embodiment.

The rotating mirror 65 rotates in a direction of an arrow shown in FIG. 10. The rotating mirror 65 directs the line shaped light L reflected from the plane mirror 52 toward the object to be measured W. The rotating mirror 65 is a polygon mirror, and includes a plurality of reflection surfaces 67 capable of reflecting the line shaped light L, for example. When the line shaped light L is reflected by the reflection surfaces 67 while the rotating mirror 65 is rotating, the line shaped light L vibrates in the length direction.

Also in the third embodiment, the light vibration part 50 rotates the rotating mirror 65 during the exposure time of the imaging part 40 to vibrate the line shaped light L in the length direction. Therefore, the imaging part 40 captures the image of the object to be measured W when the line shaped light L vibrates. Thus, even if the line shaped light L undulates in the normal direction on the surface of the object to be measured W, the image formed on the imaging surface of the imaging part 40 will have the averaged-out undulation. As a result, it is possible to suppress the measurement error of the object to be measured W in the normal direction.

The present invention is explained on the basis of the exemplary embodiments. The technical scope of the present invention is not limited to the scope explained in the above embodiments and it is possible to make various changes and modifications within the scope of the invention. For example, all or part of the apparatus can be configured with any unit which is functionally or physically dispersed or integrated. Further, new exemplary embodiments generated by arbitrary combinations of them are included in the exemplary embodiments of the present invention. Further, effects of the new exemplary embodiments brought by the combinations also have the effects of the original exemplary embodiments.

What is claimed is:

1. An optical sensor comprising:
a radiation part that irradiates an object to be measured with line shaped light; and
an imaging part that receives line shaped light reflected by the object to be measured and captures an image of the object to be measured in a predetermined exposure time, wherein
the radiation part includes:
a light generation part that generates the line shaped light, and
a light vibration part that irradiates the object to be measured with the line shaped light generated by the light generation part while vibrating the line shaped light in a length direction during the exposure time.

2. The optical sensor according to claim 1, wherein
the light vibration part irradiates the object to be measured with the line shaped light while causing the line shaped light to make at least one reciprocation in the length direction during the exposure time.

3. The optical sensor according to claim 1, wherein
the imaging part captures an image of light distribution indicating a cross-sectional shape of the object to be measured on a light-section plane, and
the light vibration part averages out undulation of the line shaped light in a normal direction of the light-section plane.

4. The optical sensor according to claim 1, wherein
the light vibration part irradiates the object to be measured with the line shaped light having a predetermined cycle in the length direction while vibrating the line shaped light such that the line shaped light L is shifted by ½ or more of the cycle.

5. The optical sensor according to claim 1, wherein
the light vibration part includes a rocking mirror that rocks about an axis orthogonal to the length direction, and vibrates the line shaped light in the length direction by rocking the rocking mirror.

6. The optical sensor according to claim 5, wherein
the rocking mirror rocks within a predetermined angular range at least once during the exposure time.

7. The optical sensor according to claim 1, wherein
the radiation part further includes a light source that emits laser light,
the light generation part deforms the laser light into the line shaped light, and
the light vibration part includes an actuator that reciprocates the light source in the length direction, and vibrates the line shaped light in the length direction by reciprocating the light source.

8. The optical sensor according to claim 1, wherein
the light vibration part includes an actuator that reciprocates lenses as the light generation part in the length direction, and vibrates the line shaped light in the length direction by reciprocating the lenses.

9. The optical sensor according to claim 1, wherein
the light vibration part includes a rotating mirror including a plurality of reflection surfaces capable of reflecting the line shaped light, and vibrates the line shaped light in the length direction by rotating the rotating mirror.

10. The optical sensor according to claim 1, further comprising:
a controller that controls an exposure of the imaging part and the vibration of the line shaped light in the length direction by the light vibration part such that they are synchronized with each other.

11. A geometry measurement apparatus comprising:
an optical sensor that includes a radiation part for irradiating an object to be measured with line shaped light, and an imaging part for receiving line shaped light reflected by the object to be measured and capturing an image of the object to be measured in a predetermined exposure time; and
a calculation part that calculates a geometry of the object to be measured on the basis of an output of the imaging part, wherein
the radiation part includes:
a light generation part that generates the line shaped light, and
a light vibration part that irradiates the object to be measured with the line shaped light generated by the light generation part while vibrating the line shaped light in a length direction during the exposure time.
